(19) United States
(12) Patent Application Publication
(10) Pub. No.: US 2005/0035135 A1
(43) Pub. Date: Feb. 17, 2005

(54) Devise for dispensing plastic bags from rolls

(76) Inventor: Alfredo Lavin Sasian, Carredana De Empaques (MX)

Correspondence Address: Arnold S. Weintraub;The Weintraub Group, Suite 240, 32000 Northwestern Highway, Farmington Hills, MI, 48334, US

(21) Appl. No.: 10/634,308

(22) Filed: Aug. 5, 2003

(30) Foreign Application Priority Data
Jul. 11, 2003 (MX) PA/U/2003/000166

(51) Int. Cl. B65H 5/28; G07F 11/68

(52) U.S. Cl. 221/70

(57) ABSTRACT

The present invention consists of a plastic bag dispenser, as used in many kinds of self-service stores, to carry and store various products. To be more specific it consists of a structure of a plastic bag dispensing device of the kind which come on a roll, used to store, keep and carry diverse articles and/or products, characterized because it consists of a box with a forward sloping ramp at the inner base of the box and four outer walls, with at least inner compartment where at least one roll of plastic bags is stored, with an inner slot on the front wall and a centrally placed hook on the compartment on the inner edge of said slot which incorporates an opposite facing slope to that of the ramp at the inner base, in order to be hooked to the slot found at the perforated line between the adjoining bags of the roll and detach the outer bag. Said box incorporates a tubular vertical piece acting as a support, fixed to a base piece on its inside.

### SCOPE OF THE INVENTION

The present invention consists of a plastic bag dispenser used in self-service stores to carry and hold various products. To be more specific it consists of a structure of a plastic bag dispensing device of the kind which come on a roll, used to store, keep and carry distinct articles and/or products.

### PRECEDENTS OF THE INVENTION

Currently, the plastic bags which come on a roll for use by consumers, are widely used in many kinds of convenience stores and are commonly found in grocery stores, supermarkets, and self service stores; such bags are often used to keep fruits and vegetables, they may also be used to store meats, seafood, bread, among many other products or tinned, bottled, boxed or loose articles.

The plastic bags manufactured in rolls with serrated transversal lines for detachment from the adjoining bag, are often found hanging from hooks supported on some kind of stand. This form of dispensing plastic bags on a roll is impractical and implies inconvenience for consumers and customers, given the need to use both hands in order to detach the bag.

Furthermore, the plastic bags dispensed from rolls, of the type described above, may easily be stolen by simply unhooking said metallic hooks.

The rolls of plastic bags for which said devise is designed, consist of a roll of plastic bags in a line and rolled in various folds to be able to form, or not, the star seal; which consists of a fold at the middle, made twice across the length of the plastic film, without the aid of a cylindrical core. A transversal perforated line for detachment adjacently joins said series of bags; they may also be wound or interconnected having already been separated.

Said roll is also characterized by the fact that each serrated transversal line incorporates a central slot.

There are some plastic bags dispensers of the kind which dispense plastic bags which come on a roll, such as those previously mentioned, and as was applied for on Mar. 13, 2002, in application Ser. No. PA/U/2002/000082; in said application it is intended to protect a dispenser of plastic bags on a roll, consisting of a box, which, at the bottom, incorporates at least one bolt acting as a spin axis for a roll of plastic bags, incorporating a fixed bracket in each corner close to upper edge of its walls, same brackets which hold in place, a lid closed by applying pressure, covering the upper opening. Said box incorporates at least one vertical slot on its front wall and one on either side; said (at least one) vertitcal slot incorporates a circular expansion at its upper extremity, through which the end of the bag of the roll of plastic bags passes. Said box incorporates at least one vertical slot with at least one curved hook, consisting of a curved section with a central oblong rim. Said rim passes the imaginary line of said vertical slot.

Said roll of bags consists of a series of bags joined by means of a perforated transversal line with a central slot between each adjoining bag to which the central oblong rim is attached for the detachment of the bags.

However, apart from being a complex structure, such dispenser in extremely heavy, and if the outer bag on the roll becomes jammed, it is necessary to open said box in order adjust the roll.

The present invention, developed in light of the foregoing, resolves the existing inconveniences and problems, resulting in a more practical and efficient detachment of the plastic bags from the roll.

### AIMS OF THE INVENTION

The principal aim of this invention is to enable a devise to dispense plastic bags from a roll, within establishments or businesses requiring the use of plastic bags to keep, hold, and carry products, allowing an easy availability of such bags.

Another aim of the invention is to enable such devise to dispense plastic bags from rolls which should also be sturdy and practical.

Another aim of the invention is to enable such devise to dispense plastic bags from rolls which should also be visually attractive and economic to manufacture.

Another aim of the invention is to enable such devise to dispense plastic bags from rolls which are also easily accessible to costumers.

Yet another aim of the invention is to enable such devise to dispense plastic bags from rolls which should also be relatively easy to load.

All of these qualities and aims shall become apparent upon the undertaking of a description of the present invention, supported by the illustrated models.

### BRIEF DESCRIPTION OF THE INVENTION

In general, the devise for dispensing plastic bags from rolls, of this invention, consists of a box with an inner base sloping towards the front, and four outer walls, with at least one inside compartment where at least one roll of plastic bags is kept. It also consists of an inside slot on the front wall and a centrally places hook on the compartment on the inside edge of such slot, which consists of an opposite facing slope to that of the base ramp, in order to be hooked to the slot found at the perforated line between the adjoining bags of the roll, and detach the outer bag. Said box incorporates a tubular vertical piece acting as a support, fixed to a base piece on its inside.

The forward sloping ramp aids the approach of the roll of plastic bags towards the front wall, facilitating the extraction and detachment of the bag by effect of the hooks.

In one of the models, said box incorporates at least one internal dividing wall, creating two compartments, each being able to store one roll of plastic bags, with the same number of hooks to the number of compartments within the inside edge of such interior slot of the front wall of said box, aligned in the central part of each compartment.

Said box may incorporate more than one dividing wall, thus creating more compartments with the same number of hooks for the detachment of the bags.

Said compartments may be of equal or distinct sizes, in order to accommodate the rolls of bags whose dimensions correspond to their respective compartments.

In one of the models, said vertical tubular piece, acting as a support, is found centrally fixed to a circular base; and in the preferred model, said supporting vertical tubular piece is eccentrically fixed to said central base, where said eccentricity is opposite the front wall of the box where the slot for extracting and detaching the bags is found, in order to avoid the entire structure leaning toward and falling on, and injuring the person while trying to detach the otter bag from the roll.

The problem of the instability of the structure of the devise may also be resolved by fixing the base to the floor or incorporating a heavier base to avoid such movements.

The box may incorporate an opening and closable upper lid.

### BRIEF DESCRIPTION OF THE DRAWINGS

FIG. 1 shows a conventional view of the devise for dispensing plastic bags from rolls.

FIG. 2 shows an elevation view of the devise for dispensing plastic bags from rolls.

FIG. 3 shows a rear view of the devise for dispensing plastic bags from rolls.

FIG. 4 shows a conventional view of the box of the devise for dispensing plastic bags from rolls, while the outer bag is being detached from the roll of plastic bags, shown in FIG. 2.

For a clearer understanding of the invention, a detailed disruption shall be made of some of the models of same, as shown in the drawings which for illustrative purposes, not to be construed as limiting, are enclosed with the description herein.

### DETAILED DESCRIPTION OF THE INVENTION

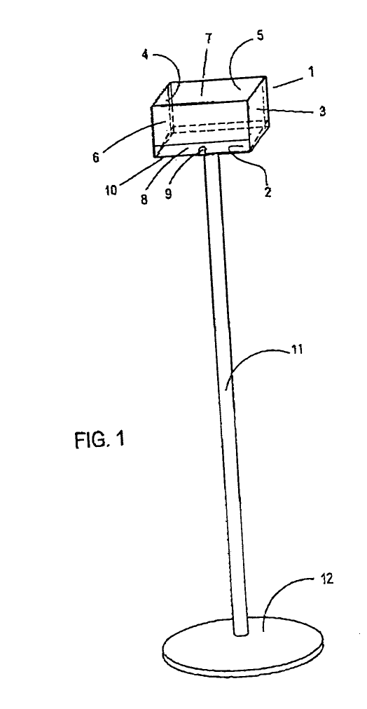

The characteristic details of the devise for dispensing plastic bags from rolls, are clearly demonstrated by the following description and the enclosed drawings. The reference numbers indicate the corresponding parts. With reference to FIG. 1, showing a conventional view of the devise for dispensing plastic bags from rolls, said devise consists of one box (1) with a bottom ramp sloping towards the front, and four walls, two lateral walls (3 and 4), a back wall (5) and a front wall (6), with at least one internal compartment (7), and an inside slot (8) on the front wall (6) which incorporates a hook (9) placed on the inside edge (10) of said inside slot (8) and centered with the inner compartment (7). Said hook enables the detachment of the outer bag from the roll of plastic bags (not shown). Said box incorporates a vertical tubular piece, acting as a support, on the inside of the box, fixed to a circular base piece (12).

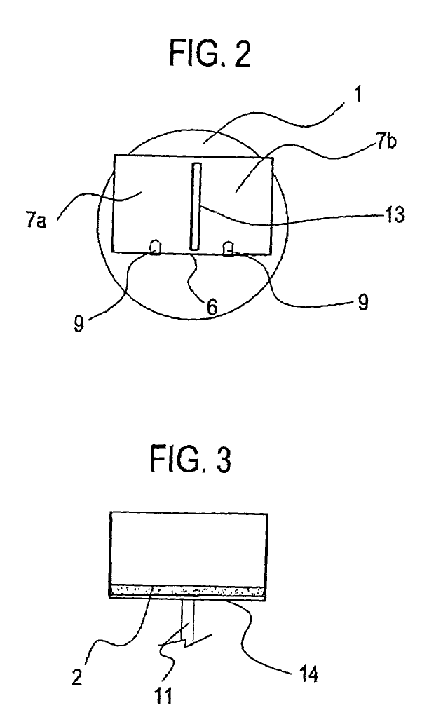

With reference to FIG. 2, showing an elevation view of the devise for dispensing plastic bags from rolls, the box (1) incorporates at least one internal dividing wall (13) thus creating two compartments (7a and 7b), each may accommodate a roll of plastic bags, with the same number or hooks (9) as compartments; said hooks (9) placed at the inside edge of said interior slot (8) (not shown) of the front wall (6) of said box (1), aligned on the central part of each compartment (7a and 7b).

With reference to FIG. 3, showing an elevation view of the devise for dispensing plastic bags from rolls, it can be seen that below the forward sloping ramp (2), a back wall (14) is incorporated which supports the vertical tubular piece (11) in order to support the box in an upright position.

The forward sloping ramp (2) favors the approach of the roll of plastic bags towards the front wall (not shown), thus facilitating the extraction and detachment of the outer bag by the effect of the hooks (not shown). However, this may also be resolved, by omitting said ramp from within the box and incorporating a flat bottom; and incorporating a diagonal slot, of a certain angle, within the vertical tubular piece (11), in such a wave that when putting the box together, it leans forward and the bottom is therefore at an angle, providing the same result.

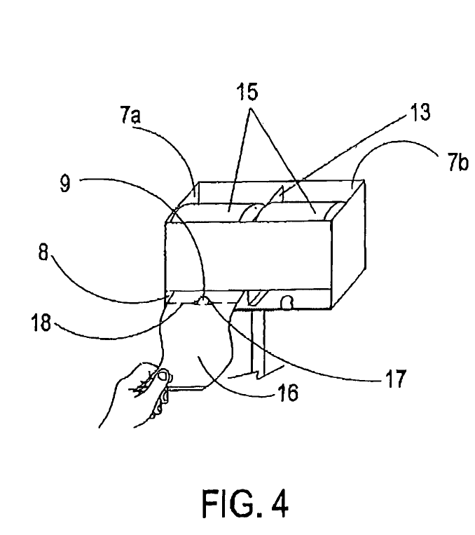

FIG. 4 shows a conventional view of the box of the devise, while the outer bag is being detached from the roll of plastic bags (shown in FIG. 2). In said figure the rolls (15) of plastic bags are found accommodated inside the compartments (7a and 7b) created by the dividing wall (13); the outer bag of one of the rolls is found extruding from the inside front slot (8) and the hook (9) is found in the slot (17) located hall way along the perforated line (18) between the adjoining bags; in such a way, that while tearing the outer bag, it becomes detached from the adjoining bag of the roll (15) of plastic bags, by means of said perforated line (18), thus leaving the next bag protruding in order to be removed and carry out the same operation.

The invention has been sufficiently described in order that, a person with average knowledge of the field, could reproduce it and obtain the results mentioned in the invention herein. However, any technically skilled person who takes on the invention herein, would be able to undertake the modifications not detailed in the present application, moreover, if, for the application of such modifications within a determined structure or within the manufacturing process of same, the material covered in the following claims is required, then such structures should be covered within the reaches of the invention.

1. A devise for dispensing plastic bags from rolls, characterized because it consists of a box with a forward sloping ramp at the inner base of the box and four outer walls, with at least one inner compartment in which at least one roll of plastic bags is stored, with an inner slot on the front wall and a centrally placed hook on the compartment on the inner edge of said slot which incorporates an opposite facing slope to that of the ramp at the inner base, in order to be hooked to the slot found at the perforated line between the adjoining bags of the roll, and detach the outer bag. Said box incorporates a tubular vertical piece acting as a support, fixed to a base piece on its inside.

2. A devise for dispensing plastic bags from rolls, in accordance with claim 1, characterized because said box incorporates at least one inner dividing wall thus creating at least two compartments of equal of distinct dimensions, in order to accommodate the rolls of bags whose dimensions correspond to their respective compartments, with an equal number of hooks as the number of compartments, and placed on the inner edge of said lower slot of the front wall of said box, aligned at the central part of each compartment.

3. A devise for dispensing plastic bags from rolls, in accordance with claim 1, characterized because said vertical tubular piece, supporting the box, is found eccentrically fixed to said central base, where said eccentricity is opposite the front wall of the box where the slot for extracting and detaching the bags is found, in order to avoid instability of the structure while detaching a bag from the roll.

4. A devise for dispensing plastic bags from rolls, in accordance with claim 1, characterized because said base is fixed to the floor or incorporating a heavier base in order to avoid instability of the structure while detaching a bag from the roll.

5. A devise for dispensing plastic bags from rolls, in accordance with claim 1, characterized because said box incorporates an openable and closeable upper lid.

6. A devise for dispensing plastic bags from rolls, in accordance with claim 1, characterized because said vertical tubular piece incorporates a diagonal slot of a certain angle at its upper extremity, placed in such a way that when putting the together, it leans forward and the previously flat bottom is therefore at a certain angle due to said diagonal slot with a certain angle of said vertical tubular piece.
